(19) United States
(12) Patent Application Publication
(10) Pub. No.: US 2017/0147053 A1
(43) Pub. Date: May 25, 2017

(54) APPLICATION DRIVEN DYNAMIC VOLTAGE AND FREQUENCY SCALING METHOD AND ASSOCIATED MACHINE READABLE MEDIUM

(71) Applicant: MEDIATEK INC., Hsin-Chu (TW)

(72) Inventors: Shen-Kai Chang, Hsinchu County (TW); Lu-Chia Tseng, Hsinchu City (TW)

(21) Appl. No.: 15/275,499

(22) Filed: Sep. 26, 2016

Related U.S. Application Data
(60) Provisional application No. 62/258,542, filed on Nov. 23, 2015.

(51) Int. Cl. G06F 1/32

(52) U.S. Cl. CPC G06F 1/324

(57) ABSTRACT

A dynamic voltage and frequency scaling (DVFS) method includes obtaining at least one DVFS demand for DVFS of a processor system, and generating a control command of the DVFS of the processor system according to the at least one DVFS demand. The at least one DVFS demand includes a DVFS demand derived from an application demand, and the application demand is obtained from an application running on the processor system.

### CROSS REFERENCE TO RELATED APPLICATIONS

This application claims the benefit of U.S. provisional application No. 62/258,542, filed on Nov. 23, 2015 and incorporated herein by reference.

### BACKGROUND

The present invention relates to a dynamic voltage and frequency scaling (DVFS) design, and more particularly, to an application driven DVFS method and associated machine readable medium.

Generally speaking, power consumption is an important issue for processor intensive applications on mobile devices. With the continuous technology advance, the traditional single-core architecture may not be able to deal with processor intensive applications. Hence, the multi-core architecture may be employed to improve the processor performance. Specifically, multiple processor cores permit extremely high parallelism for some applications. Unfortunately, using the multi-core architecture is inevitable to bring higher power consumption, which could tremendously raise the chip temperature and absorb considerable battery power. The power/performance balance control will be a key point for such applications on mobile platforms.

Dynamic voltage and frequency scaling (DVFS) is a dynamic power management technique in computer architecture by scaling the operating voltage and the operating frequency of each processor core. To achieve balance between processor performance and the power consumption, the conventional DVFS method determines a system demand by monitoring the system-wise processor utilization of a mobile device periodically, and adjusts the operating voltage and the operating frequency of each processor core accordingly. However, the conventional DVFS method can only react to system-wise processor utilization changes, and does not consider actual demands of individual applications running on the mobile device.

### SUMMARY

One of the objectives of the claimed invention is to provide an application driven dynamic voltage and frequency scaling (DVFS) method and associated machine readable medium.

According to a first aspect of the present invention, an exemplary dynamic voltage and frequency scaling (DVFS) method is disclosed. The exemplary DVFS method includes: obtaining at least one DVFS demand for DVFS of a processor system, wherein the at least one DVFS demand includes a DVFS demand derived from an application demand, and the application demand is obtained from an application running on the processor system; and generating a control command of the DVFS of the processor system according to the at least one DVFS demand.

According to a second aspect of the present invention, an exemplary non-transitory machine readable medium is disclosed. The non-transitory machine readable medium has a program code stored therein. When executed by a processor system, the program code instructs the processor system to perform following steps: obtaining at least one dynamic voltage and frequency scaling (DVFS) demand for DVFS of the processor system, wherein the at least one DVFS demand includes a DVFS demand derived from an application demand, and the application demand is obtained from an application running on the processor system; and generating a control command of the DVFS of the processor system according to the at least one DVFS demand.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to an embodiment of the present invention.

FIG. 2 is a diagram illustrating a framework of a DVFS control design according to an embodiment of the present invention.

FIG. 3 is a flowchart illustrating a method of generating an applicant demand for a software video decoder according to an embodiment of the present invention.

FIG. 4 is a flowchart illustrating a method of generating an applicant demand for a user interface application according to an embodiment of the present invention.

FIG. 5 is a flowchart illustrating a method of generating an applicant demand for a camera snapshot application according to an embodiment of the present invention.

FIG. 6 is a diagram illustrating the DVFS control module shown in FIG. 2 according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

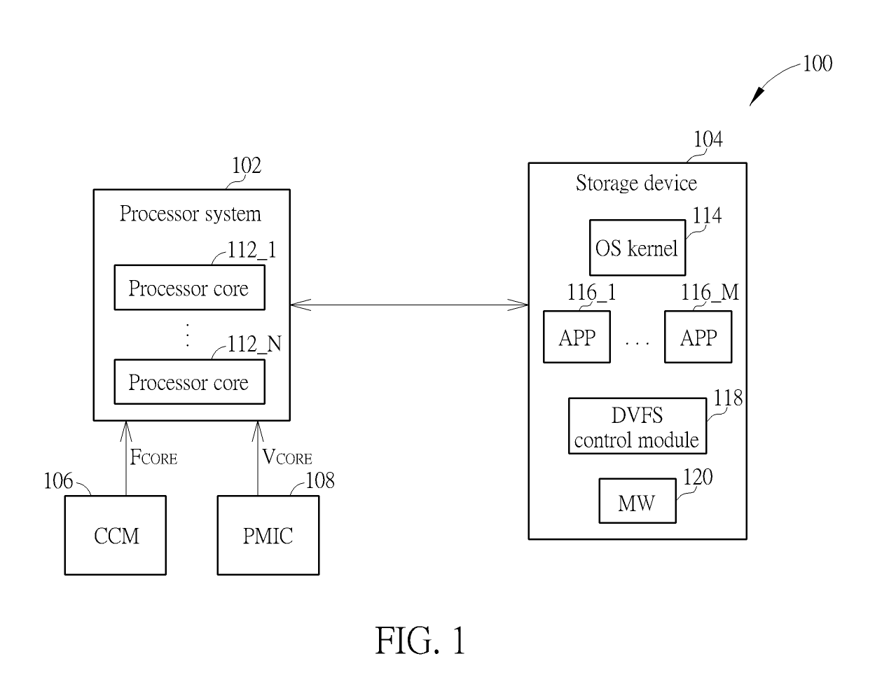

FIG. 1 is a diagram illustrating an electronic device according to an embodiment of the present invention. By way of example, but not limitation, the electronic device 100 may be a mobile device powered by a battery device. The electronic device 100 includes a processor system 102, a storage device 104, a clock control module (CCM) 106, and a power management integrated circuit (PMIC) 108. It should be noted that only the components pertinent to the present invention are illustrated in FIG. 1. In practice, the electronic device 100 may include additional components to achieve other designated functions. For example, the electronic device 100 may further have a display screen (e.g., a touch screen) for displaying a user interface (UI), an image output, a video output, etc. For another example, the electronic device 100 may further have a camera module used for still image capture and/or video recording.

The processor system 102 includes one or more processor cores 112_1-112_N, where N is a positive integer not smaller than one (i.e., N≧1). For example, when the processor system 102 employs the single-core architecture, the processor system 102 has only one processor core 112_1 (N=1). For another example, when the processor system 102 employs the multi-core architecture, the processor system 102 has multiple processor cores 112_1-112_N (N>1). To put it simply, the application driven DVFS design proposed by the present invention is application to single-core architecture and multi-core architecture.

The storage device 104 is a non-transitory machine readable medium. For example, the storage device 104 may be a non-volatile memory such as a flash memory. The storage device 104 has a plurality of software modules (i.e., program codes) stored therein. When any of the software modules is loaded and executed by the processor system 102, the processor system 102 is instructed to perform the designated function of the software module. As shown in FIG. 1, the software modules may include an operating system (OS) kernel 114 such as a Linux-based kernel, one or more applications (APPs) 116_1-116_M (M is a positive integer not smaller than one), one proposed DVFS control module (denoted by S_{DVFS}) 118, and middleware (MW) 120.

The CCM 106 is responsible for setting the operating frequency F_{CORE} of each processor core. The PMIC 108 is responsible for providing the operating voltage V_{CORE} to each processor core. When the proposed DVFS control module 118 is loaded and executed by the processor system 102, an application driven DVFS method is operative to dynamically generate a control command that will cause the operating frequency F_{CORE} to be adjusted by CCM 106 and the operating voltage V_{CORE} to be adjusted by PMIC 108, thereby achieving DVFS of the processing system 102. Further details of the application driven DVFS method are described later.

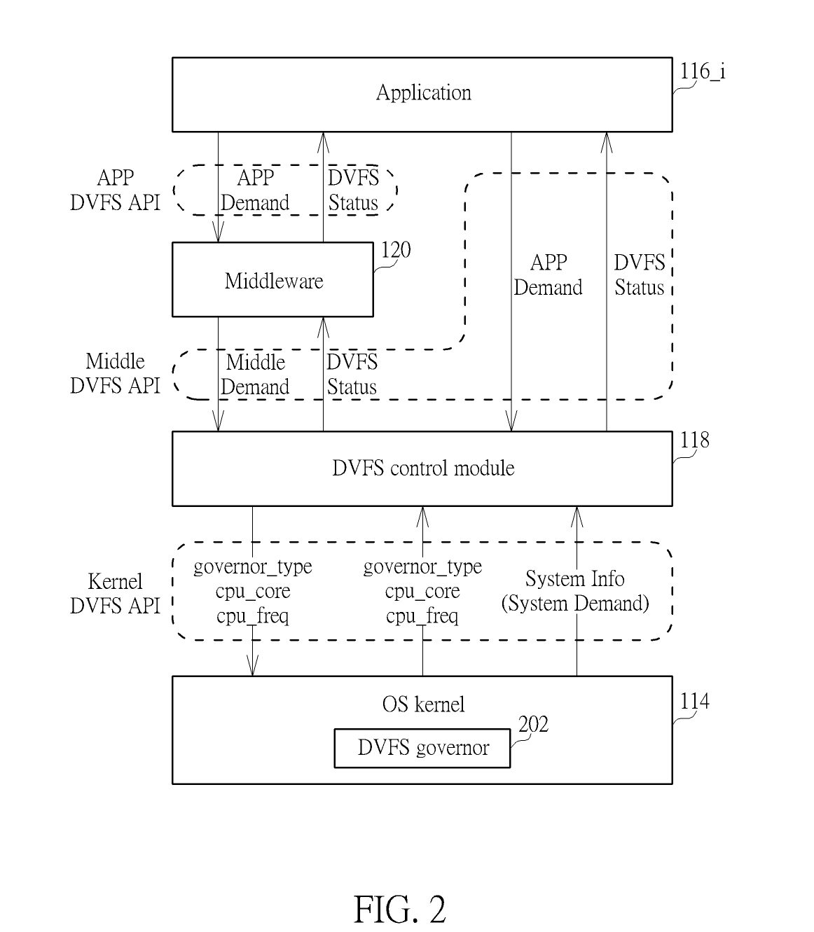

FIG. 2 is a diagram illustrating a framework of a DVFS control design according to an embodiment of the present invention. For clarity and simplicity, only one application is included in the framework. The application 116_i may be any of the applications 116_1-116_M shown in FIG. 1, where 1≦i≦M. In addition, the OS kernel (e.g., Linux-based kernel) 114 includes a DVFS governor 202 which is responsible for instructing the CCM 106 to adjust the operating frequency F_{CORE} of each processor core and instructing the PMIC 108 to adjust the operating voltage V_{CORE} of each processor core.

The application 116_i may communicate with the middleware 120 via a first application programming interface (denoted by “APP DVFS API”), and may communicate with the DVFS control module 118 via a second application programming interface (denoted by “Middle DVFS API”). The middleware 120 may communicate with the DVFS control module 118 via the second application programming interface (denoted by “Middle DVFS API”). The DVFS control module 118 may communicate with the OS kernel 114 via a third application programming interface (denoted by “Kernel DVFS API”).

The DVFS control module 118 is configured to support the proposed application driven DVFS method. Hence, the DVFS control module 118 obtains at least one DVFS demand for DVFS of the processor system 102, wherein the at least one DVFS demand includes a DVFS demand derived from an application demand (denoted by “APP demand”), and the application demand is obtained from the application 116_i running on the processor system 102. In one exemplary design, the application demand may directly act as the DVFS demand, and may be obtained by the DVFS control module 118 via the Middle DVFS API between the application 116_i and the DVFS control module 118. In another exemplary design, the application demand may be obtained by middleware 120 via the APP DVFS API between the application 116_i and the middleware 120. The application demand may be processed by the middleware 120. Hence, the middleware 120 may generate the DVFS demand (denoted by “Middle demand”) according to at least the application demand, and may output the DVFS demand (which is generated based at least partly on the application demand) to the DVFS control module 118 via the Middle DVFS API between the middleware 120 and the DVFS control module 118.

In this embodiment, the application demand may be actively issued from the application 116_i to request DVFS of the processor system 102. For example, the application 116_i may determine the application demand according to at least one performance index of the application 116_i and/or workload prediction of the application 116_i. For better understanding of the technical features, examples of determining the application demands under different applications are given as below.

In a first embodiment, the application 116_i may be a software video decoder. The workload of the software video decoder rises periodically according to the video frame rate. Further, the complexity of video frames may be different. The software video decoder, however, requires smooth video playback despite any workload variation and complexity variation in video frames. Hence, the software video decoder may prepare one application demand for DVFS of the processor system 102 when it starts to decode a new video frame.

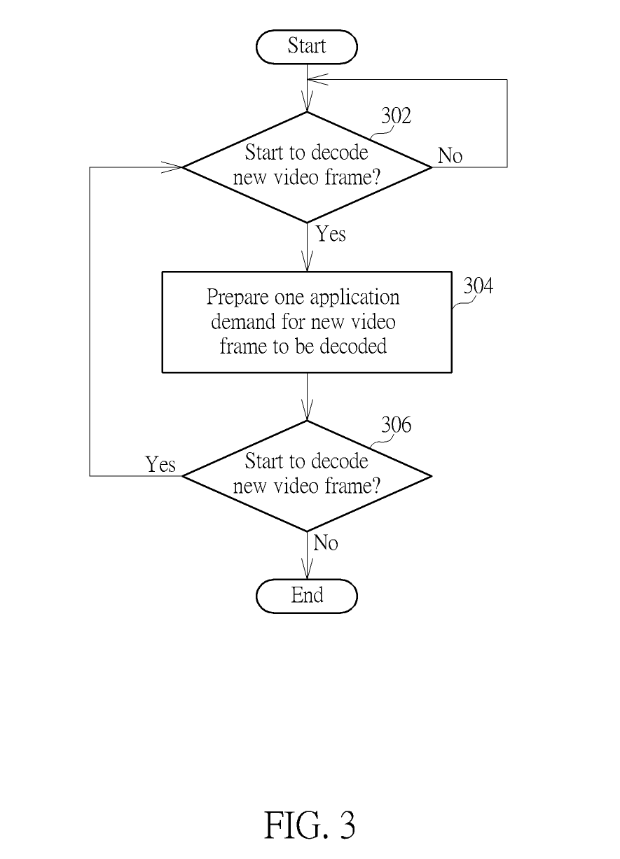

FIG. 3 is a flowchart illustrating a method of generating an applicant demand for a software video decoder according to an embodiment of the present invention. After the software video decoding is started, the application 116_i (e.g., software video decoder) checks if decoding of a new video frame is about to be started (step 302). If yes, the flow proceeds with step 304; otherwise, step 302 is performed again. In step 304, the application 116_i (e.g., software video decoder) prepares an application demand for the new video frame to be decoded. For example, at the beginning of decoding the new video frame, the application 116_i (e.g., software video decoder) determines the application demand according to at least one of a video resolution, an input buffer size, an output buffer level, synchronization of video and audio, a frame type, a frame rate, and other information in a frame header. The output buffer level and the synchronization of video and audio may be used as application-specific performance indices. The input buffer size, the video resolution, the frame type and the frame rate may be used as application-specific workload prediction.

The video resolution is correlated to a frame size of each video frame. Hence, more computing power may be needed by the software video decoder if the video resolution is higher. The input buffer size is correlated to a size of an input video bitstream of the new video frame to be decoded. Hence, more computing power may be needed by the software video decoder if the input buffer size is larger. The output buffer level is correlated to the number of decoded video frames that are currently available in an output buffer and ready to be displayed. Hence, more computing power may be needed by the software video decoder if the output buffer level is lower. The synchronization of video and audio may be represented by a difference between the current video playback time and the current audio playback time. Hence, more computing power may be needed by the software video decoder if the value of (current video playback time minus current audio playback time) is smaller. The video type is correlated to the decoding complexity/workload. Hence, video frames with different frame types may have different decoding complexity and thus may require different computing power of the software video decoder. The frame rate is correlated to the decoding workload. Hence, video sequences with different frame rates may require different computing power of the software video decoder.

After the application demand is determined, the flow proceeds with step 306 to check if there are video frames not decoded yet. If yes, the flow proceeds with step 302; otherwise, the software video decoding is ended.

In a second embodiment, the application 116_i may be a user interface (UI) application used for controlling a UI displayed on a screen (e.g., a touch screen) of the electronic device 100. The workload of the UI application comes along with a user input that may be generated by touching the touch screen or clicking a button. Generally speaking, the UI application requires a quick response to the user input, and thus all of its works should be done in a short period of time. The UI application therefore may prepare one application demand for DVFS of the processor system 102 upon receiving one user input.

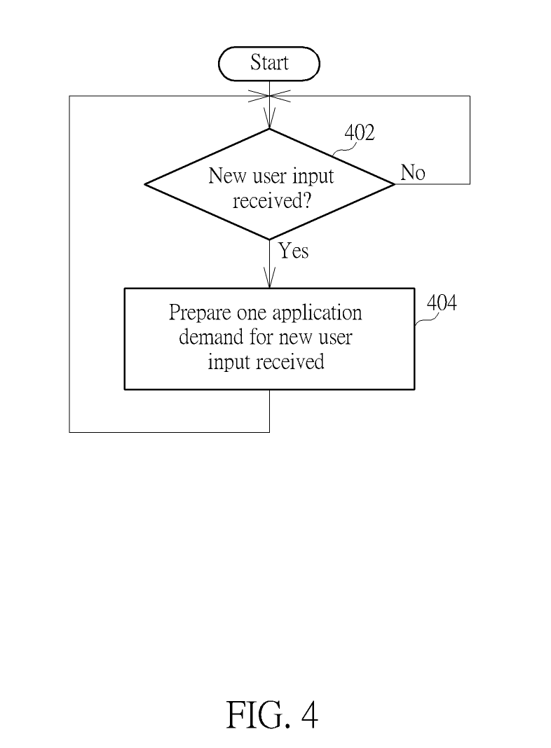

FIG. 4 is a flowchart illustrating a method of generating an applicant demand for a user interface application according to an embodiment of the present invention. After the UI function is in operation, the application 116i (e.g., UI application) checks if there is a new user input received (step 402). If yes, the flow proceeds with step 404; otherwise, step 402 is performed again. In step 404, the application 116_i (e.g., UI application) prepares an application demand for the new user input received. For example, upon receiving the new user input, the application 116_i (e.g., UI application) determines the application demand according to application-specific workload prediction, such as at least one of the complexity of drawing all graphics, the complexity of showing all required contents, and the time it can take to complete the UI response to the new user input. For example, more computing power may be needed by the UI application if the complexity of drawing all graphics is higher; more computing power may be needed by the UI application if the complexity of showing all required contents is higher; and more computing power may be needed by the UI application if the time it can take to complete the UI response to the new user input is shorter. After the application demand is determined, the flow proceeds with step 402 to check if there is any new user input received.

In a third embodiment, the application 116_i may be a camera snapshot application. The workload of camera snapshot comes from user's snapshot command issued during video recording. The camera snapshot needs to quickly capture a photo without affecting the on-going video recording. Hence, the camera snapshot application may prepare one application demand for DVFS of the processor system 102 upon receiving one snapshot command.

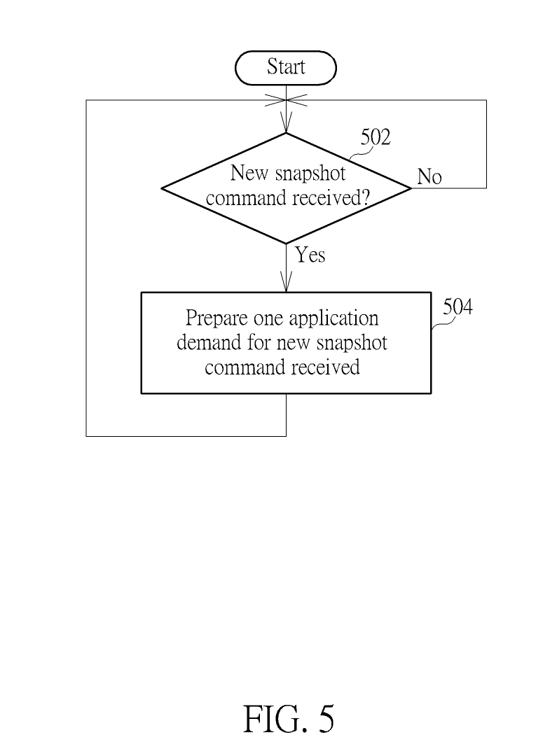

FIG. 5 is a flowchart illustrating a method of generating an applicant demand for a camera snapshot application according to an embodiment of the present invention. After the video recording is in operation, the application 116_i (e.g., camera snapshot application) checks if there is a new snapshot command received (step 502). If yes, the flow proceeds with step 504; otherwise, step 502 is performed again. In step 504, the application 116_i (e.g., camera snapshot application) prepares an application demand for the new snapshot command received. For example, upon receiving the new snapshot command, the application 116_i (e.g., camera snapshot application) determines the application demand according to application-specific workload prediction, such as the complexity of photo capturing and the complexity of video recording. For example, the complexity of photo capturing may be evaluated based on at least one of the photo size and the photo quality; and the complexity of video recording may be evaluated based on at least one of the video frame size, the video frame rate, the video bit rate and the video quality. Since the camera snapshot occurs while the video recording is in operation, more computing power may be needed by the camera snapshot application if the complexity of photo capturing is higher and/or the complexity of video recording capturing is higher. After the application demand is determined, the flow proceeds with step 502 to check if there is any new snapshot command received.

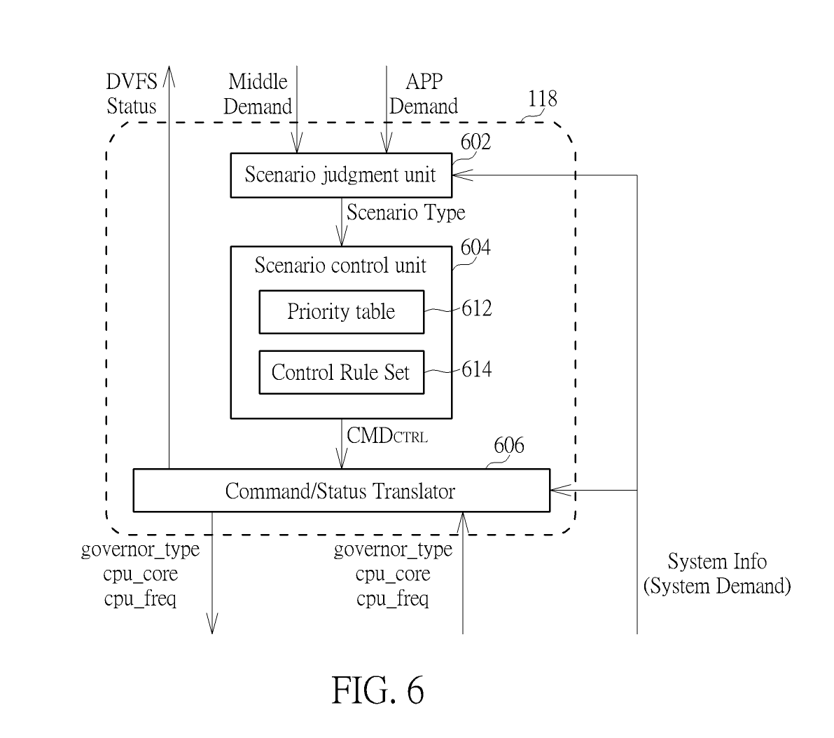

As mentioned above, the DVFS control module 118 is operative to dynamically generate a control command that will cause the operating frequency F_{CORE} to be adjusted by CCM 106 and the operating voltage V_{CORE} to be adjusted by PMIC 108 for achieving DVFS of the processing system 102. FIG. 6 is a diagram illustrating the DVFS control module 118 shown in FIG. 2 according to an embodiment of the present invention. In this embodiment, the DVFS control module 118 includes a scenario judgment unit 602, a scenario control unit 604 and a command/status translator 606, where the scenario control unit 604 includes a priority table 612 and a control rule set 614. In addition to the application demand directly obtained from the application 116_i (or the middle demand which is generated based at least partly on the application demand obtained from the application 116_i), the DVFS control module 118 may further obtain system information (denoted by “System info”) from the OS kernel 114, particularly the DVFS governor 202. For example, the DVFS governor 202 may determine a system demand by monitoring system-wise processor utilization periodically.

In this embodiment, the DVFS control module 118 may take all DVFS demands, including the system demand and application demand(s) (or middle demand(s) generated based on the application demand(s)), into consideration. A middle demand may be generated based on an application demand. Hence, the middle demand may be regarded as an application demand transmitted via the Middle DVFS API. For clarity and simplicity, the terms “application demand” and “middle demand” may be interchangeable in the present invention.

The scenario judgment unit 602 performs scenario judgment to select a scenario type from a plurality of candidate scenario types according to the DVFS demands. That is, the scenario judgment unit 602 receives all kinds of DVFS demands (e.g., system demand generated by OS kernel and application demand(s) generated by application(s)), and judges which scenario type should be adopted. Hence, different scenario types may be selected for different combinations of system demand and application demand(s), respectively.

The scenario control unit 604 sets the control command CMD_{CTRL} of DVFS of the processor system 102 in response to the selected scenario type. For example, the scenario control unit 604 obtains priority information of each of the DVFS demands under the selected scenario type, obtains control rules associated with the selected scenario type, and sets the control command CMD_{CTRL} of DVFS of the processor system 102 according to priority information of the DVFS demands and the control rules. In this embodiment, the priority table 612 is a lookup table that records pre-defined priority information of DVFS demands under each of the candidate scenario types. Hence, the scenario control unit 604 can search the priority table 612 for the priority information of each of DVFS demands under the selected scenario type. In addition, the control rule set 614 records pre-defined control rules for each of the candidate scenario types. Hence, the scenario control unit 604 can obtain the control rules associated with the selected scenario type from the control rule set 614. The control rules associated with the selected scenario type define how to set the final control command CMD_{CTRL} according to DVFS demands with designated priority.

After the control command CMD_{CTRL} is set by the scenario control unit 604, the command/status translator 606 translates the generalized control command CMD_{CTRL} into kernel dependent commands such as governor_type, cpu_core and cpu_freq. The governor_type command records an expected governor type for the DVFS governor 202 used. The cpu_core command records an expected value of the operating voltage V_{CORE}. The cpu_freq command records an expected value of the operating frequency F_{CORE}. Hence, the command/status translator 606 outputs the kernel dependent commands to the OS kernel 114 running on the processor system 102, such that the DVFS governor 202 of the OS kernel 114 controls the DVFS of the processor system 102 according to the kernel dependent commands transmitted via the Kernel DVFS API.

In this embodiment, the DVFS control module 118 further returns a DVFS status of the processor system 102 to the application 116_i. For example, the DVFS control module 118 transmits the DVFS status to the application 116_i via the Middle DVFS API between the DVFS control module 118 and the application 116_i. For another example, the DVFS control module 118 transmits the DVFS status to the middleware 120 via the Middle DVFS API between the DVFS control module 118 and the middleware 120, and the middleware 120 outputs the DVFS status to the application 116_i via the APP DVFS API between the middleware 120 and the application 116_i. As shown in FIG. 2 and FIG. 6, the OS kernel 114 outputs kernel dependent information (e.g., governor_type, cpu_core, cpu_freq) to the command/status translator 606, where the governor_type information records an actual governor type of the DVFS governor 202, the cpu_core information records an actual value of the operating voltage V_{CORE} that is set by the DVFS governor 202, and the cpu_freq information records an actual value of the operating frequency F_{CORE} that is set by the DVFS governor 202. The command/status translator 606 translates the generalized kernel dependent information (e.g., governor_type, cpu_core, cpu_freq) into a DVFS status, and outputs the DVFS status to the middleware 120 or the application 116_i.

It should be noted that the actual governor type of the DVFS governor 202 as indicated by the governor_type information may be same as or different from the expected governor type of the DVFS governor 202 as requested by the governor_type command, depending upon actual design considerations. Similarly, the actual value of the operating voltage V_{CORE} as indicated by the cpu_core information may be same as or different from the expected value of the operating voltage V_{CORE} as requested by the cpu-core command, depending upon actual design considerations. The actual value of the operating frequency F_{CORE} as indicated by the cpu_freq information may be same as or different from the expected value of the operating frequency F_{CORE} as requested by the cpu-freq command, depending upon actual design considerations.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A dynamic voltage and frequency scaling (DVFS) method comprising:
obtaining at least one DVFS demand for DVFS of a processor system, wherein the at least one DVFS demand includes a DVFS demand derived from an application demand, and the application demand is obtained from an application running on the processor system; and
generating a control command of the DVFS of the processor system according to the at least one DVFS demand.

2. The DVFS method of claim 1, wherein the application demand is actively issued from the application; and the application is one of a software video decoder, a user interface (UI) application, and a camera snapshot application.

3. The DVFS method of claim 1, wherein the application demand directly acts as the DVFS demand.

4. The DVFS method of claim 1, wherein the application demand is processed by middleware, and the middleware generates the DVFS demand according to at least the application demand.

5. The DVFS method of claim 1, wherein the application demand is determined according to at least one performance index of the application or workload prediction of the application; or wherein the at least one DVFS demand further includes a system demand issued from an operating system (OS) kernel running on the processor system.

6. The DVFS method of claim 1, wherein generating the control command of the DVFS of the processor system according to the at least one DVFS demand comprises:
performing scenario judgment to select a scenario type from a plurality of candidate scenario types according to the at least one DVFS demand; and
setting the control command of the DVFS of the processor system in response to the selected scenario type.

7. The DVFS method of claim 6, wherein setting the DVFS control command of the processor system in response to the selected scenario type comprises:
obtaining priority information of each of the at least one DVFS demand under the selected scenario type;
obtaining control rules associated with the selected scenario type; and
setting the control command of the DVFS of the processor system according to priority information of the at least one DVFS demand and the control rules.

8. The DVFS method of claim 7, wherein obtaining the priority information of each of the at least one DVFS demand under the selected scenario type comprises:
searching a priority table for the priority information of each of the at least one DVFS demand under the selected scenario type, wherein the priority table records pre-defined priority information of DVFS demands under each of the candidate scenario types.

9. The DVFS method of claim 7, wherein obtaining the control rules associated with the selected scenario type comprises:
obtaining the control rules associated with the selected scenario type from a control rule set, wherein the control rule set records pre-defined control rules for each of the candidate scenario types.

10. The DVFS method of claim 6, wherein generating the control command of the DVFS of the processor system according to the at least one DVFS demand further comprises:
translating the control command into kernel dependent commands; and
outputting the kernel dependent commands to an operating system (OS) kernel running on the processor system, wherein the OS kernel includes a DVFS governor which controls the DVFS of the processor system according to the kernel dependent commands.

11. A non-transitory machine readable medium having a program code stored therein, wherein when executed by a processor system, the program code instructs the processor system to perform following steps:
obtaining at least one dynamic voltage and frequency scaling (DVFS) demand for DVFS of the processor system, wherein the at least one DVFS demand includes a DVFS demand derived from an application demand, and the application demand is obtained from an application running on the processor system; and
generating a control command of the DVFS of the processor system according to the at least one DVFS demand.

12. The non-transitory machine readable medium of claim 11, wherein the application demand is actively issued from the application; and the application is one of a software video decoder, a user interface (UI) application, and a camera snapshot application.

13. The non-transitory machine readable medium of claim 11, wherein obtaining the at least one DVFS demand for the DVFS of the processor system comprises:
directly receiving the application demand from the application as the DVFS demand.

14. The non-transitory machine readable medium of claim 11, wherein obtaining the at least one DVFS demand for the DVFS of the processor system comprises:
receiving the DVFS demand from middleware, wherein the application demand is processed by the middleware, and the middleware generates the DVFS demand according to at least the application demand.

15. The non-transitory machine readable medium of claim 11, wherein the application demand is determined according to at least one performance index of the application or workload prediction of the application; or wherein obtaining the at least one DVFS demand for the DVFS of the processor system comprises:
obtaining a system demand issued from an operating system (OS) kernel running on the processor system as one of the at least one DVFS demand.

16. The non-transitory machine readable medium of claim 11, wherein generating the control command of the DVFS of the processor system according to the at least one DVFS demand comprises:
performing scenario judgment to select a scenario type from a plurality of candidate scenario types according to the at least one DVFS demand; and
setting the control command of the DVFS of the processor system in response to the selected scenario type.

17. The non-transitory machine readable medium of claim 16, wherein setting the DVFS control command of the processor system in response to the selected scenario type comprises:
obtaining priority information of each of the at least one DVFS demand under the selected scenario type;
obtaining control rules associated with the selected scenario type; and
setting the control command of the DVFS of the processor system according to priority information of the at least one DVFS demand and the control rules.

18. The non-transitory machine readable medium of claim 17, wherein obtaining the priority information of each of the at least one DVFS demand under the selected scenario type comprises:
searching a priority table for the priority information of each of the at least one DVFS demand under the selected scenario type, wherein the priority table records pre-defined priority information of DVFS demands under each of the candidate scenario types.

19. The non-transitory machine readable medium of claim 17, wherein obtaining the control rules associated with the selected scenario type comprises:
obtaining the control rules associated with the selected scenario type from a control rule set, wherein the control rule set records pre-defined control rules for each of the candidate scenario types.

20. The non-transitory machine readable medium of claim 16, wherein generating the control command of the DVFS of the processor system according to the at least one DVFS demand further comprises:
translating the control command into kernel dependent commands; and
outputting the kernel dependent commands to an operating system (OS) kernel running on the processor system, wherein the OS kernel includes a DVFS governor which controls the DVFS of the processor system according to the kernel dependent commands.
